(19) United States
(12) Patent Application Publication
(10) Pub. No.: US 2013/0271676 A1
(43) Pub. Date: Oct. 17, 2013

(54) DISPLAY DEVICE

(71) Applicant: SAMSUNG DISPLAY CO., LTD., Yongin-city (KR)

(72) Inventor: NamHeung KIM, Seoul (KR)

(73) Assignee: SAMSUNG DISPLAY CO., LTD., Yongin-city (KR)

(21) Appl. No.: 13/736,517

(22) Filed: Jan. 8, 2013

(30) Foreign Application Priority Data
Apr. 13, 2012 (KR) 10-2012-0038669

(51) Int. Cl. G02B 27/22; G02B 27/26

(52) U.S. Cl. CPC G02B 27/22; G02B 27/2214; G02B 27/26
USPC 349/15; 359/465

(57) ABSTRACT

A display device including a first display substrate, a second display substrate, and an optical member. The second display substrate is provided with a light-shielding layer. The light-shielding layer includes a light-shielding part and parts having a plurality of openings, and the optical member includes a left-eye retarder, a right-eye retarder, and an image blocking portion. The image blocking portion overlaps the light-shielding part, and a width of the light-shielding part is substantially the same as that of the image blocking portion. The presence of the image blocking portion results in a greater vertical viewing angle of the display device and an increased aperture ratio of the display device.

### CROSS-REFERENCE TO RELATED APPLICATION

This application claims priority from and the benefit of Korean Patent Application No. 10-2012-0038669, filed on Apr. 13, 2012, which is hereby incorporated by reference for all purposes as if fully set forth herein.

### BACKGROUND

1. FIELD

Exemplary embodiments of the present invention relate to a display device, and more particularly, to a display device displaying a three-dimensional image.

2. DISCUSSION OF THE BACKGROUND

A display device displays a three-dimensional image by using a stereoscopic technique or autostereoscopic technique.

The stereoscopic technique may be classified as a glasses-type stereoscopic technique or a non-glasses-type stereoscopic technique. According to the glasses-type stereoscopic technique, polarizing directions of a left-eye image and a right-eye image are changed by using a patterned retarder to provide the three-dimensional image.

When the left-eye image is provided to the right eye of a user or the right-eye image is provided to the left eye of the user, i.e., when crosstalk occurs, visibility of the three-dimensional image is degraded.

To provide a high-quality image, the display device should have many small pixels. As the size of the pixels is reduced, elements of the pixels also become smaller. Accordingly, a vertical viewing angle is decreased, and crosstalk increases. When the vertical viewing angle is increased to prevent crosstalk, an aperture ratio of the pixel is decreased.

The above information disclosed in this Background section is only for enhancement of understanding of the background of the invention and therefore it may contain information that does not form any part of the prior art nor what the prior art may suggest to a person of ordinary skill in the art.

### SUMMARY

Exemplary embodiments of the present invention provide a display device having an increased aperture ratio and decreased crosstalk.

Additional features of the invention will be set forth in the description which follows, and in part will be apparent from the description, or may be learned by practice of the invention.

An exemplary embodiment of the present invention discloses a first substrate, a second substrate, and an optical member. The first and second substrates are separated from each other. The optical member may be disposed on the second substrate.

The second substrate may include a first transmissive area, a second transmissive area, and a non-transmissive area disposed between the first transmissive area and the second transmissive area. The first transmissive area may include a plurality of transmissive parts arranged in a first direction, the second transmissive area may include a plurality of transmissive parts arranged in the first direction and may be separated from the first transmissive area in a second direction crossing the first direction.

The optical member may include a left-eye retarder, a right-eye retarder, and an image blocking portion. The left-eye retarder may overlap the first transmissive area, the right-eye retarder may overlap the second transmissive area, and the image blocking portion may overlap the non-transmissive area and have substantially the same width as the non-transmissive area.

An exemplary embodiment of the present invention also discloses a display device including a first substrate and a second substrate disposed on the first substrate. The second substrate may include a light-shielding layer provided with a first part having a plurality of openings, a second part having a plurality of openings and disposed in parallel with the first part, and a light-shielding part disposed between the first part and the second part. The display device may also include an optical member disposed on the second substrate which includes a left-eye retarder overlapping the first part, a right-eye retarder overlapping the second part, and an image blocking portion disposed between the left-eye retarder and the right-eye retarder and overlapping the light-shielding part, wherein the. The ratio of one of the width of the light-shielding part and the width of the image blocking portion to the other width may be about 1:1 to about 1:0.8.

An exemplary embodiment of the present invention also discloses a display device including a display panel including a first display row having a plurality of display parts arranged in a first direction, a second display row having a plurality of display parts arranged in the first direction, and a non-display row disposed between the first display row and the second display row, the second display row being separated from the first display row in a second direction perpendicular to the first direction. A polarizing plate may be disposed on the display panel, and an optical member may be disposed on the polarizing plate. The optical member may include a left-eye retarder overlapping the first display row, a right-eye retarder overlapping the second display row, and an image blocking portion disposed between the left-eye retarder and the right-eye retarder which overlaps the non-display row. The width of the non-display row with respect to the second direction is substantially the same as a width of the image blocking portion with respect to the second direction.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description serve to explain the principles of the invention.

FIG. 1 is an explanatory diagram illustrating a display device according to a first exemplary embodiment of the present invention.

FIG. 2A is an exploded perspective view illustrating the display panel illustrated in FIG. 1.

FIG. 2B is a cross-sectional view illustrating the display panel of FIG. 2A sectioned along line I-I′.

FIG. 3 is a cross-sectional view illustrating a display panel according to a second exemplary embodiment of the present invention.

FIG. 4 is a diagram illustrating a vertical viewing angle of the display device illustrated in FIG. 1.

FIG. 5 is a diagram for comparing vertical viewing angles of display devices.

FIGS. 6A and 6B are diagrams illustrating vertical viewing angles of display devices according to third and fourth exemplary embodiments of the present invention.

FIG. 7A is a planar view illustrating the optical member of FIG. 1.

FIG. 7B is a cross-sectional view illustrating the optical member of FIG. 7A sectioned along line II-II′.

FIG. 8 is a cross-sectional view illustrating an optical member according to a fifth exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ.

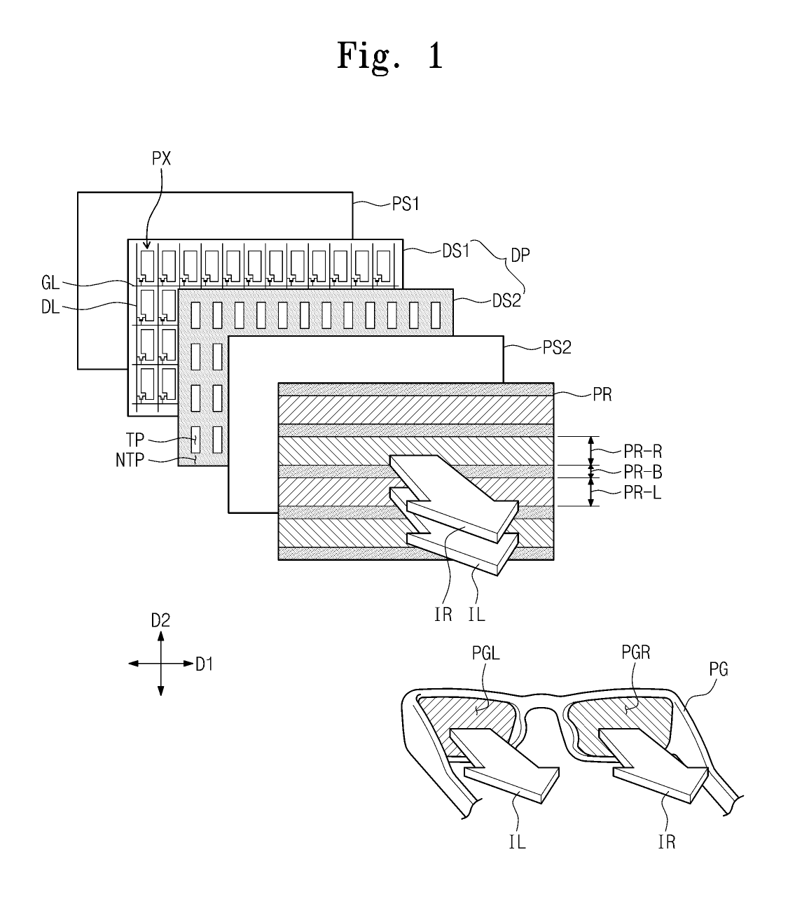

FIG. 1 is an explanatory diagram illustrating a display device according to a first exemplary embodiment of present invention. As illustrated in FIG. 1, the display device includes a display panel DP and an optical member PR arranged on the display panel DP.

The display panel DP is not limited to a particular type. For example, a liquid crystal display panel, an organic light emitting display panel, a plasma display panel, an electrophoretic display panel, an electrowetting display panel, etc., may be adopted. In the present exemplary embodiment, the liquid crystal display panel is described. The display device may further include a backlight unit (not illustrated) which provides light to the liquid crystal display panel.

The display panel DP displays a first image in a two-dimensional mode and displays a second image in a three-dimensional mode. The first image is a planar image, and the second image is a stereoscopic image including a left-eye image and a right-eye image. The display device is driven in the two-dimensional or three-dimensional mode in response to a control signal inputted according a user's selection.

The display panel DP includes a first display substrate DS1 and a second display substrate DS2. The first display substrate DS1 is provided with a plurality of pixels PX. The first display substrate DS1 is also provided with a plurality of signal lines which provide driving signals to the plurality of pixels PX. The plurality of signal lines include a plurality of gate lines GL and a plurality of data lines DL. The gate lines GL extend in a first direction D1 and are arranged in a second direction D2 crossing the first direction D1. The data lines DL and the gate lines GL cross and are insulated from each other.

The second display substrate (DS2) is arranged on the first display substrate (DS1). The second display substrate DS2 is divided into transmissive parts TP, through which the light provided from the backlight unit is transmitted, and a peripheral part NTP, through which the light is not transmitted. The peripheral part NTP may surround the transmissive parts TP. The transmissive parts TP may be arranged in the form of a matrix.

The display device includes at least one polarizing plate. As illustrated in FIG. 1, the display device may include a first polarizing plate PS1 and a second polarizing plate PS2, wherein the liquid crystal display panel DP is disposed therebetween. The first polarizing plate PS1 has a first transmission axis, and the second polarizing plate PS2 has a second transmission axis. The first transmission axis of the first polarizing plate PS1 and the second transmission axis of the second polarizing plate PS2 may be parallel to or cross each other. The number of the polarizing plates may be varied. For example, the first polarizing plate PS1 may not be provided to a self-light emitting display panel, such as an organic light emitting display panel, and a transflective display panel, such as an electrophoretic display panel.

The optical member PR converts, according to a region thereof, a part of light provided from the second polarizing plate PS2 to a first polarization-type light and converts another part of the light to a second polarization-type light which is different from the first polarized light.

The optical member PR includes at least one left-eye retarder PR-L, at least one right-eye retarder PR-R, and an image blocking portion PR-B disposed between the left-eye retarder PR-L and the right-eye retarder PR-R.

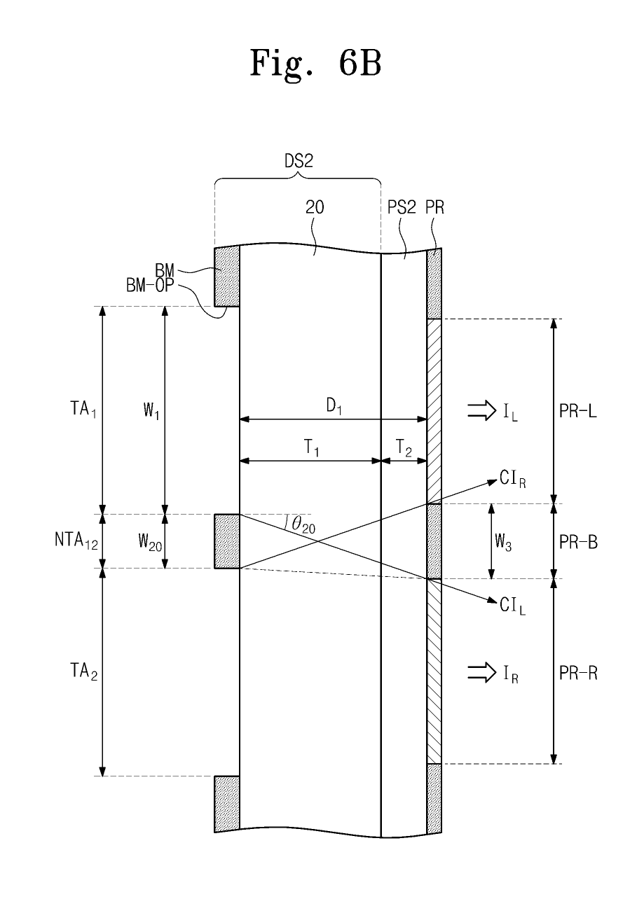

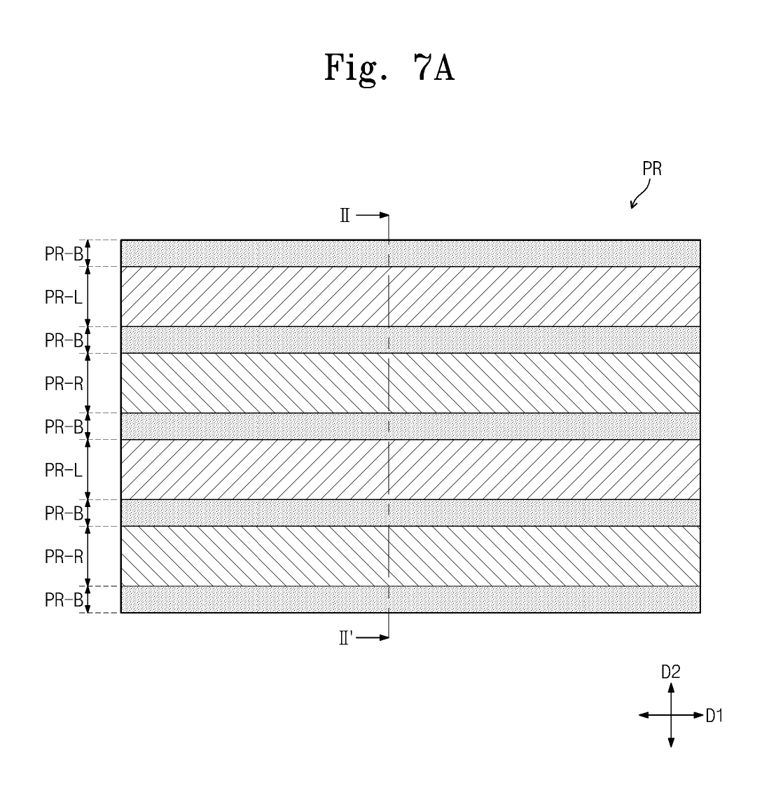

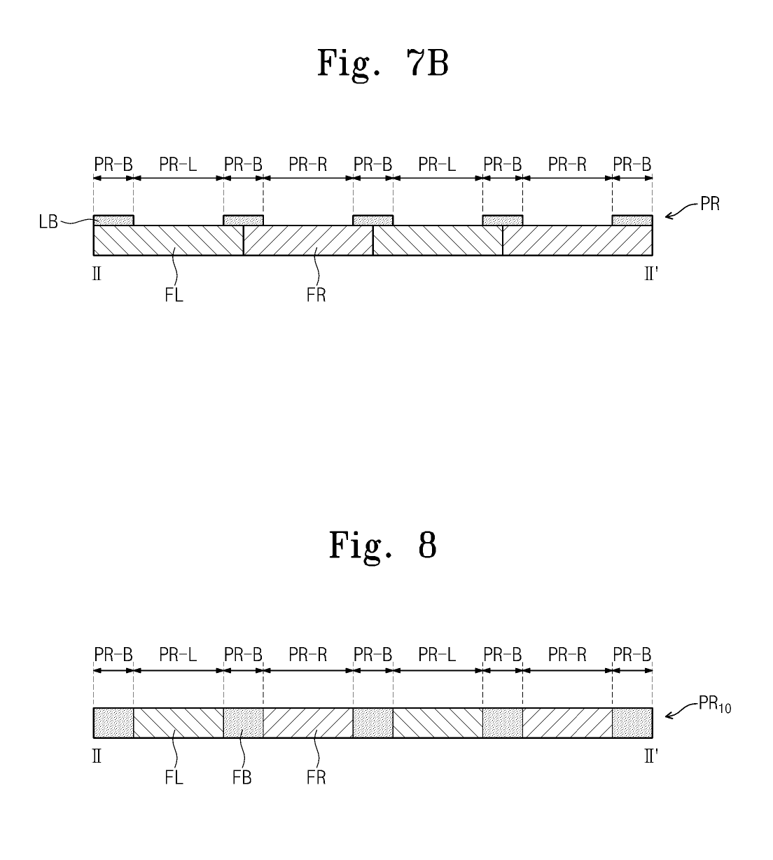

For example, the optical member PR may left-circularly polarize a left-eye image I_{L} transmitted through the second polarizing plate PS2 and right-circularly polarize a right-eye image I_{R} transmitted through the second polarizing plate PS2. The optical member will be described in more detail with reference to FIGS. 7 to 8B.

The left-eye image I_{L} and right-eye image I_{R} are respectively provided to the left and right eyes of a user through optical glasses PG. The optical glasses PG include a left-eye lens PG-L and a right-eye lens PG-R having different optical axes. The left-eye lens PG-L may have the same optical axis as the left-eye retarder PR-L, and the right-eye lens PG-R may have the same optical axis as the right-eye retarder PR-R.

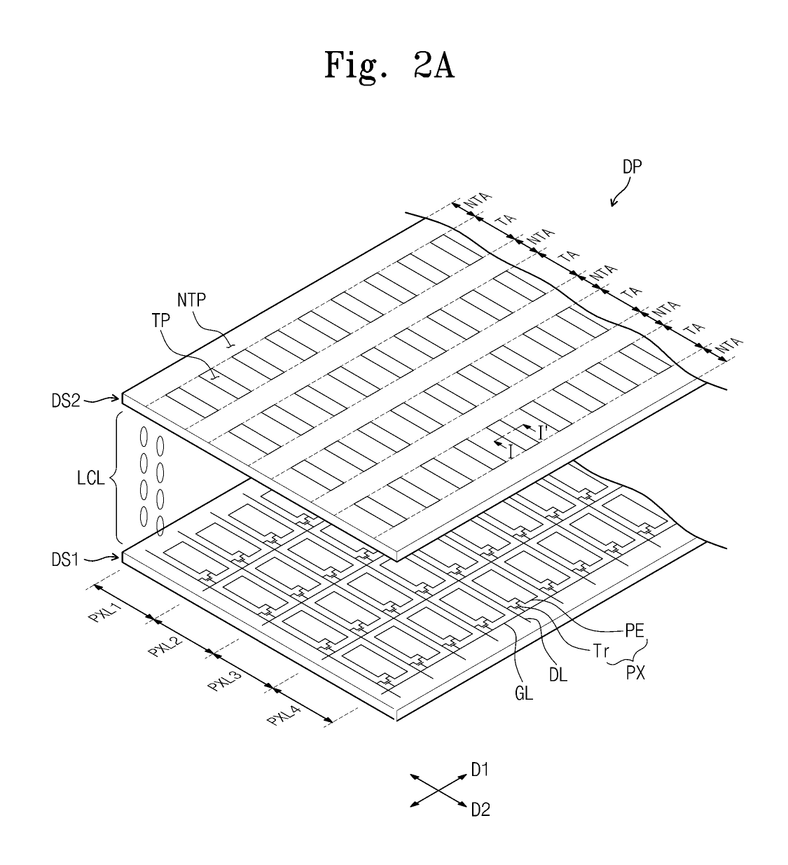

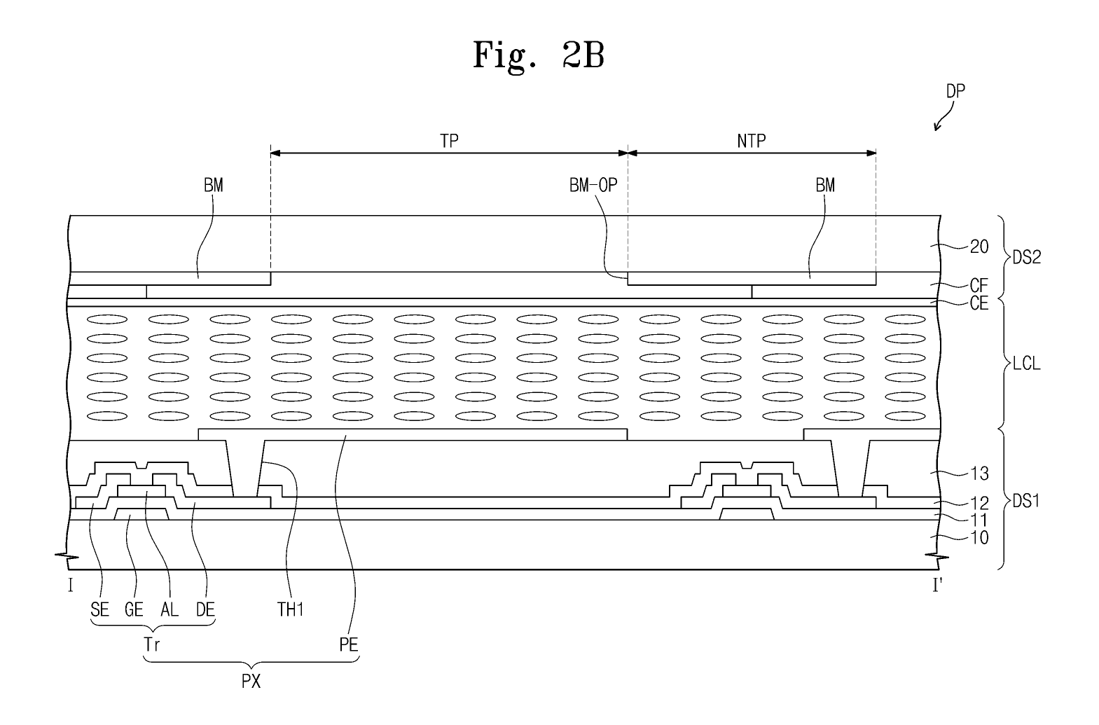

FIG. 2A is an exploded perspective view illustrating the display panel illustrated in FIG. 1, and FIG. 2B is a cross-sectional view illustrating the display panel sectioned along line I-I′.

As illustrated in FIG. 2A, the first display substrate DS1 is provided with pixels PX at every intersection of the data lines DL and gate lines GL. Each of the pixels is provided with a transistor Tr connected to one of the data lines DL and one of the gate lines GL, and a pixel electrode PE connected to the transistor Tr.

The first display substrate DS1 includes a plurality of pixel rows PXL₁ to PXL₄. FIG. 2 illustrates four pixel rows PXL₁ to PXL₄ provided to the first display substrate DS1. Each of the pixel rows PXL₁ to PXL₄ includes a plurality of pixels PX arranged in the first direction D1. The pixel rows PXL₁ to PXL₄ are arranged in the second direction.

As illustrated in FIG. 2B, the transistor Tr is disposed on a first base substrate 10. The transistor Tr includes a gate electrode GE, a semiconductor layer AL, a source electrode SE, and a drain electrode DE.

The gate electrode GE branches from one of the gate lines GL. A gate dielectric 11 which covers the gate electrode GE is disposed on the first base substrate 10. The semiconductor layer AL is disposed on the gate dielectric 11. The semiconductor layer AL is disposed on the gate dielectric 11 in the shape of an island so as to overlap the gate electrode GE. On the gate dielectric 11, the source electrode SE branched from one of the data lines DE is provided, and the drain electrode DE separated from the source electrode SE is provided.

A protective layer 12 which covers the source electrode SE and drain electrode DE may be disposed on the gate dielectric 11, and a planarizing layer 13 may be disposed on the protective layer 12.

The pixel electrode PE is disposed on the protective layer 12 or planarizing layer 13. The pixel electrode PE is connected to the drain electrode DE through a contact hole TH1 which penetrates the planarizing layer 13 and protective layer 12.

As illustrated in FIG. 2B, the second display substrate DS2 includes a second base substrate 20 and a light-shielding layer BM disposed thereon. The light-shielding layer BL is provided with at least one opening BM-OP. Although one opening BM-OP is illustrated in FIG. 2B, the light-shielding layer BM is provided with the same number of openings BM-OP as the number of the transmissive parts TP illustrated in FIG. 2A.

The second display substrate DS2 may further include color filters CF overlapping the openings BM-OP. A common electrode CE may be disposed on the color filters CF. The color filters CF and common electrode CE may be disposed on the first base substrate 10.

A liquid crystal layer LCL having a plurality of liquid crystal particles is disposed between the first display substrate DS1 and the second display substrate DS2.

As illustrated in FIG. 2A, the second display substrate DS2 is divided into a plurality of transmissive areas and a plurality of non-transmissive areas NTA on a plane. The transmissive areas TA and the non-transmissive areas NTA extend in the first direction D1, and are alternately arranged in the second direction D2.

Each of the transmissive areas TA includes the transmissive parts TP arranged in the first direction D1. The non-transmissive areas NTA are arranged between adjacent two transmissive areas TA.

With respect to the display panel DP, the transmissive parts constitute display parts, the transmissive areas TA of the second display substrate DS2 constitute display rows, and the non-transmissive areas NTA of the second display substrate DS2 constitute non-display rows.

The transmissive areas TA respectively overlap the pixel rows PXL₁ to PXL₄. The non-transmissive areas NTA overlap a boundary of successive two pixel rows. Accordingly, each of the non-transmissive areas NTA overlaps both of successive two pixel rows.

In the three-dimensional mode, a portion of the pixel rows PXL₁ to PXL₄ receives left-eye image data, and the other part of the pixel rows receives right-eye image data. For example, the odd-numbered pixel rows PXL₁ and PXL₃ may receive the left-eye image data, and the even-numbered pixel rows PXL₂ and PXL₄ may receive the right-eye image data. With respect to the display panel DP, partial display rows of the display rows generate left-eye images and the other partial display rows generate right-eye images.

Two successive transmissive areas TA having the non-transmissive area NTA disposed therebetween respectively overlap the successive left-eye retarder PR-L (see FIG. 1) and right-eye retarder PR-R (see FIG. 1) having the image blocking portion PR-B (see FIG. 1) disposed therebetween. The non-transmissive area NTA disposed between the successive two transmissive areas TA overlaps the image blocking portion PR-B (see FIG. 1) disposed between the left-eye retarder PR-L and the right-eye retarder PR-R.

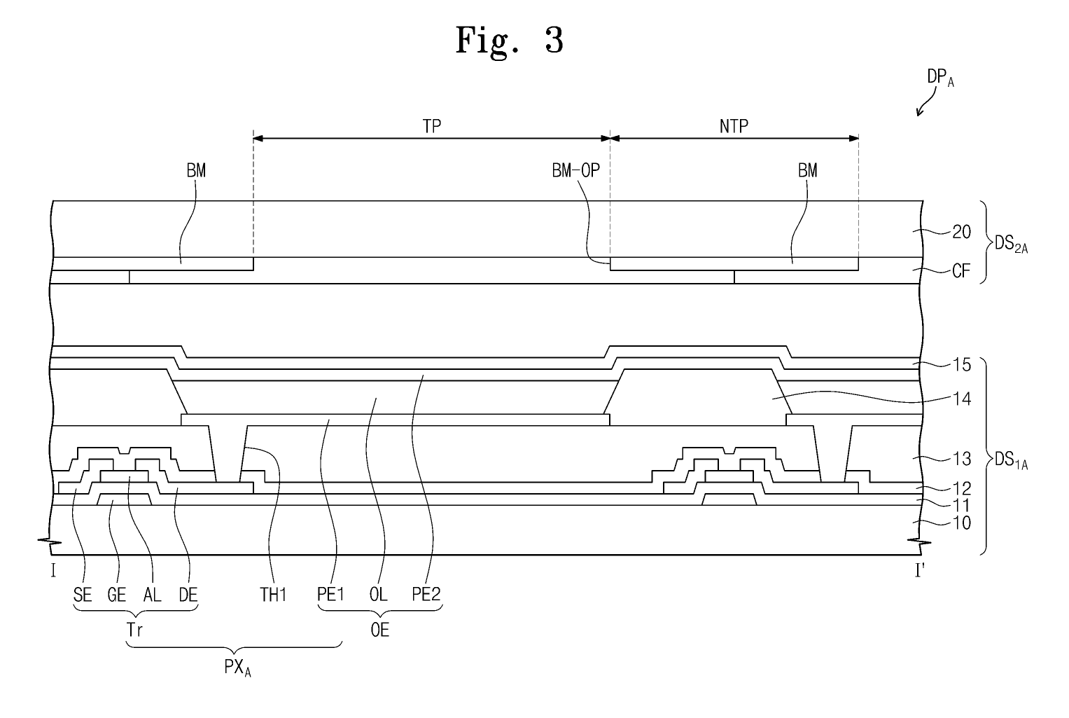

A display panel according to a second exemplary embodiment includes pixels which are configured differently from the pixels PX of the liquid crystal display panel. As illustrated in FIG. 3, a pixel PX_{A} of an organic light emitting display panel DP_{A} includes an organic light emitting element OE. The organic light emitting element OE includes a first electrode PE1 disposed on the protective layer 12 or planarizing layer 13, an organic light emitting layer OL disposed on the first electrode PE1, and a second electrode PE2 disposed on the organic light emitting layer OL. A partition wall (14), which defines an area of the pixel PX_{A}, is disposed on the protective layer 12 or planarizing layer 13. An encapsulating layer 15 is disposed on the second electrode PE2. The planarizing layer 13 may be omitted.

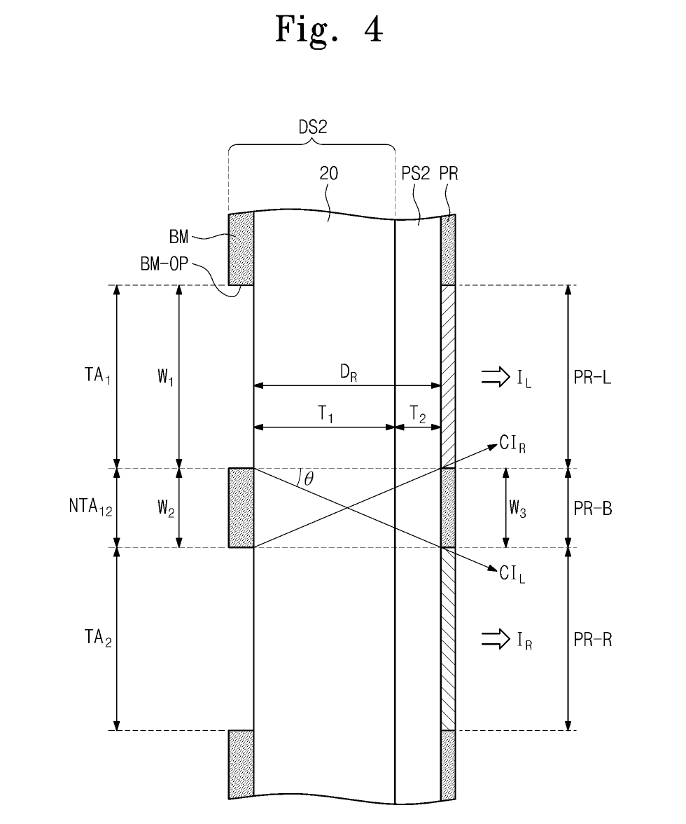

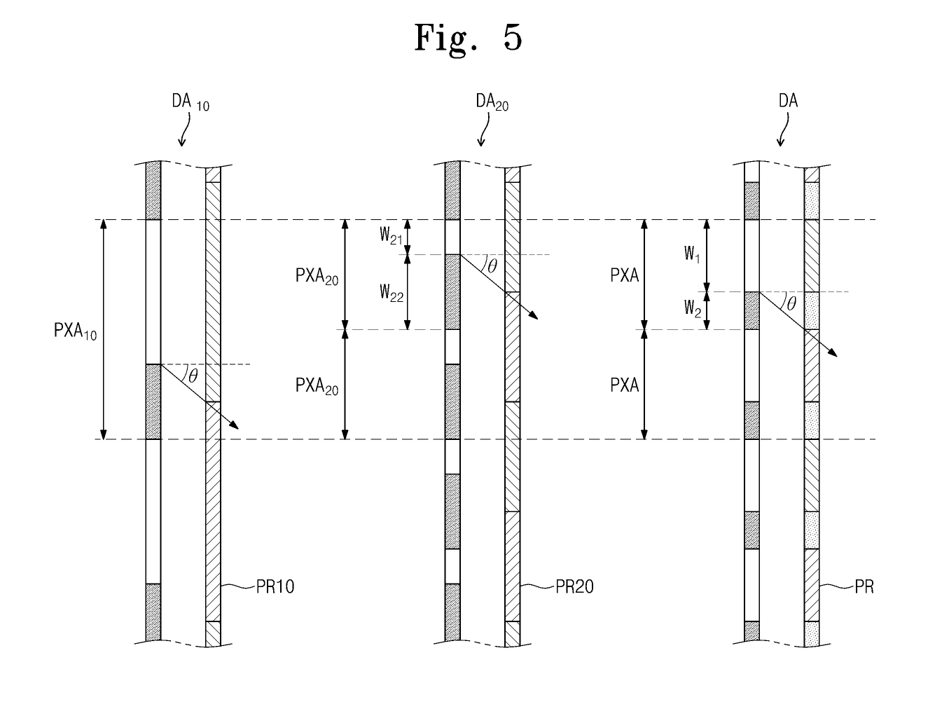

FIG. 4 is a diagram illustrating a vertical viewing angle of the display device illustrated in FIG. 1, and FIG. 5 is a diagram for comparing vertical viewing angles of display devices. In FIGS. 4 and 5, successive first transmissive area TA₁ and second transmissive area TA₂ having a single non-transmissive area NTA₁₂ disposed therebetween are magnified.

An aperture ratio of the pixel PX depends on a width W₁ of the opening BM-OP corresponding thereto. Widths of the first transmissive area TA₁ and second transmissive area TA₂ are the same as the width W₁ of the opening BM-OP.

A vertical viewing angle θ depends on a width W₂ of the non-transmissive area NTA₁₂ disposed between the first transmissive area TA₁ and the second transmissive layer TA₂, and depends on a width W₃ of the image blocking portion PR-B corresponding to the non-transmissive area NTA₁₂. Herein, at the vertical viewing angle θ, the crosstalk occurs. That is, when an angle of a viewpoint of a user is greater than the vertical viewing angle θ, the user recognizes noise images CI_{R} and CI_{L}. Herein, the noise images CI_{R} or CI_{L} is the left-eye image which has passed through the right-eye retarder PR-R or the right-eye image which has passed through the left-eye retarder PR-L.

As illustrated in FIG. 4, when the width W₂ of the non-transmissive area NTA₁₂ is substantially the same as the width W₃ of the corresponding image blocking portion PR-B, and the non-transmissive area NTA₁₂ exactly overlaps the corresponding image blocking portion PR-B, the display device has a maximum aperture ratio of the pixel PX on the premise of the constant vertical viewing angle θ.

On the premise of the constant vertical viewing angle 0, the width W₂ of the non-transmissive area NTA₁₂ and the width W₃ of the corresponding image blocking portion PR-B are determined by a distance Dᵣ between the light-shielding layer BM and the optical member PR, i.e., a thickness T₁ of the second base substrate 20 and a thickness T₂ of the second polarizing plate PS2.

The display devices illustrated in FIG. 5 all have the same vertical viewing angle θ. A third display device DA is a display device according to a first exemplary embodiment of the present invention, and a first display device DA10 and a second display device DA20 are typical display devices. The first and second display devices DA10 and DA20 are respectively provided with optical members PR10 and PR20 lacking the image blocking portion.

The second display device DA20 and third display device DA are respectively provided with two pixel areas PXA20 and two pixel areas PXA corresponding to one pixel area PXA10 of the first display device DA10. Herein, each width of the pixel areas PXA10, PXA20, and PXA is the same as a sum of a width of one transmissive area and a width of one non-transmissive area.

The second display device DA20 has more pixels than the first display device DA10 having the same area as the second display device DA20, and thus the second display device DA20 has higher resolution. However, the second display device DA20 has a lower aperture ratio than the first display device DA10. Therefore, luminance of the second display device DA20 is less than that of the first display device DA10.

The third display device DA has substantially the same resolution as the second display device DA20. The width W₂ of the non-transmissive area of the third display device DA is smaller than a width W₂₂ of the non-transmissive area of the second display device DA20, and the width W₁ of the transmissive area of the third display device DA is greater than a width W₂₁ of the transmissive area of the second display device DA20. Accordingly, the third display device DA has a higher aperture ratio than the second display device DA20. The luminance of the third display device DA is similar to that of the first display device DA10.

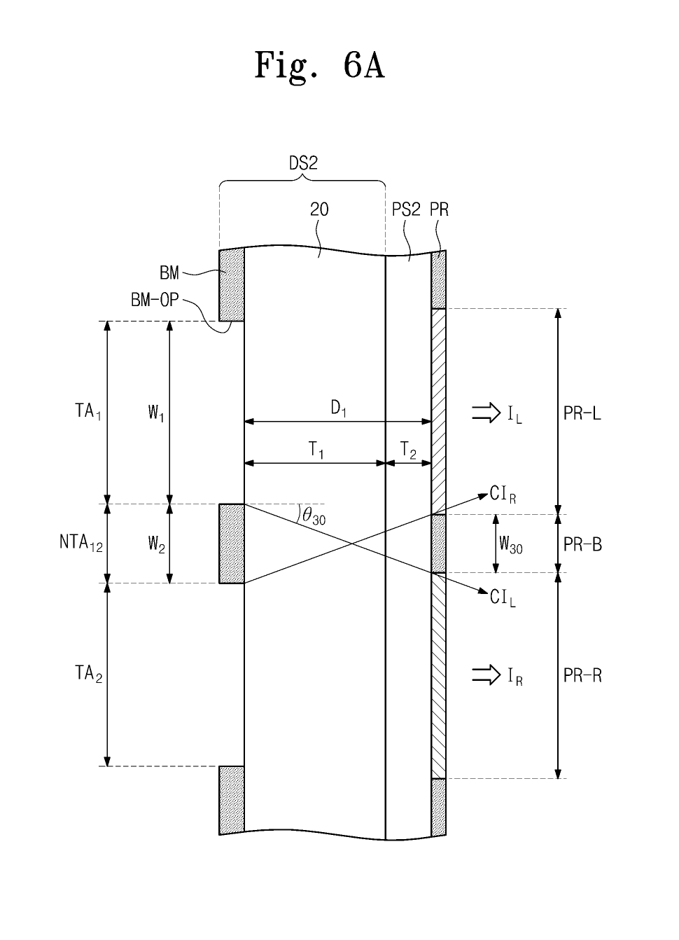

FIGS. 6A and 6B are diagrams illustrating vertical viewing angles of display devices according to third and fourth exemplary embodiments of the present invention. Descriptions of the same configurations as the display devices of FIGS. 1 to 4 are not provided.

As illustrated in FIGS. 6A and 6B, the width W₂ or W₂₀ of the non-transmissive area NTA₁₂ disposed between the first transmissive area TA₁ and the second transmissive area TA₂ may not be equal to the width W₃₀ or W₃ of the image blocking portion PR-B overlapping the non-transmissive area NTA₁₂.

As illustrated in FIG. 6A, the width W₂ of the non-transmissive area NTA₁₂ may be greater than the width W₃₀ of the image blocking portion PR-B. As illustrated in FIG. 6B, the width W₂₀ of the non-transmissive area NTA₁₂ may be smaller than the width W₃ of the image blocking portion PR-B.

As illustrated in FIG. 6A, in the case where the width W₃₀ of the image blocking portion PR-B is less than the width W₂ of the non-transmissive area NTA₁₂, misalignment, which occurs when the optical member PR is coupled to the second display substrate DS2, is prevented.

That is, because the widths of the left-eye retarder PR-L and right-eye retarder PR-R are respectively greater than those of the first transmissive area TA₁ and second transmissive area TA₂, even though the misalignment occurs, the first transmissive area TA₁ and second transmissive area TA₂ may respectively overlap the left-eye retarder PR-L and right-eye retarder PR-R.

As illustrated in FIG. 6B, in the case where the width W₂₀ of the non-transmissive area NTA₁₂ is less than the width W₃ of the image blocking portion PR-B, the aperture ratio also increases. Accordingly, a planar image with high luminance may be provided in the two-dimensional mode.

In order to prevent vertical viewing angles θ₃₀ and θ₂₀ of the display devices respectively illustrated in FIGS. 6A and 6B from decreasing below a reference value, the smaller of the width of the non-transmissive area NTA₁₂ and the width of the image blocking portion PR-B may be about 80% or more of the other. The smaller of the width of the non-transmissive area NTA₁₂ and the width of the image blocking portion PR-B may be about 90% or more of the other.

In view of the vertical viewing angle and aperture ratio, the width of the non-transmissive area NTA₁₂ and the width of the image blocking portion PR-B may be substantially the same. However, even though the width of the non-transmissive area NTA₁₂ and the width of the image blocking portion PR-B differ from each other by as much as 20%, the transmissive area NTA₁₂ and the image blocking portion PR-B may be used.

FIG. 7A is a planar view illustrating the optical member of FIG. 1, and FIG. 7B is a cross-sectional view illustrating the optical member sectioned along line II-II′. As described above with reference to FIG. 1, the optical member RP includes the at least one left-eye retarder PR-L, the at least one right-eye retarder PR-R, and the image blocking portion PR-B disposed therebetween.

The left-eye retarder PR-L may be a first optical film FL having a first slow axis, and the right-eye retarder PR-R may be a second optical film FR having a second slow axis that is different from the first slow axis. The first optical film FL and the second optical film FR may include any suitable material that can circularly or elliptically polarize light.

Linearly polarized light which is incident onto the first optical film FL may be circularly polarized light or elliptically polarized light of a first polarization type. In contrast, linearly polarized light which is incident into the second optical film FR may be circularly polarized light or elliptically polarized light of a second polarization type.

For example, an angle between the first slow axis and the transmission axis of the second polarizing plate PS2 (see FIG. 1) may be approximately positive 45 degrees, and an angle between the second slow axis and the transmission axis of the second polarizing plate PS2 may be approximately negative 45 degrees. Herein, the incident light onto the first optical film FL may be left-circularly polarized, and the incident light onto the second optical film FR may be right-circularly polarized.

The image blocking portion PR-B may include a dye or pigment. The image blocking portion PR-B may be a black layer LB disposed on one side of the first optical film FL or second optical film FR. The image blocking portion PR-B may overlap a boundary of the first optical film FL and second optical film FR.

The black layer LB is shaped as a line which extends in the first direction D1 on a plane. The black layer LB absorbs a part of the light which is incident into the first optical film FL or second optical film FR.

FIG. 8 is a cross-sectional view illustrating an optical member according to a fifth exemplary embodiment of the present invention. As illustrated in FIG. 8, the image blocking portion PR-B of an optical member PR₁₀ may be a third optical film FB which is disposed between the first optical film FL and the second optical film FR and may include a dye or pigment.

The third optical film FB has a line shape which extends in the first direction D1 on a plane. The third optical film FB may have a black color. The third optical film FB absorbs a part of light which is incident onto the optical member PR₁₀.

As described above, because the width of the light-shielding unit is decreased, the to aperture ratio of the display device increases. Accordingly, the luminance of the display device increases.

Even though the width of the light-shielding unit is decreased, a wide vertical viewing angle can be secured by the image blocking portion. In other words, a vertical viewing angle for preventing crosstalk between left and right images can be secured.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device comprising:
a first substrate;
a second substrate disposed on the first substrate and comprising a first transmissive area comprising a plurality of transmissive parts arranged in a first direction, a second transmissive area comprising a plurality of transmissive parts arranged in the first direction, and a non-transmissive area disposed between the first and second transmissive areas, wherein the second transmissive area is separated from the first transmissive area in a second direction crossing the first direction; and
an optical member disposed on the second substrate and comprising a left-eye retarder overlapping the first transmissive area, a right-eye retarder overlapping the second transmissive area, and an image blocking portion overlapping the non-transmissive area and having substantially the same width as the non-transmissive area.

2. The display device of claim 1, wherein the first substrate comprises:
a first pixel row comprising a plurality of pixels arranged in the first direction; and
a second pixel row adjacent to the first pixel row and comprising a plurality of pixels arranged in the first direction.

3. The display device of claim 2, wherein the first transmissive area and the second transmissive area respectively overlap the first pixel row and the second pixel row, and the non- transmissive area overlaps a boundary of the first and second pixel rows, a part of the first pixel row, and a part of the second pixel row.

4. The display device of claim 2, further comprising a liquid crystal layer disposed between the first substrate and the second substrate.

5. The display device of claim 4, wherein
the first substrate comprises a plurality of signal lines,
the second substrate comprises a light-shielding layer comprising a plurality of openings corresponding to the transmissive parts of the first and second transmissive areas and a common electrode disposed on the light-shielding layer, and
each of the pixels of the first and second pixel rows comprises:
a transistor connected to corresponding signal lines among the plurality of signal lines; and
a pixel electrode connected to the transistor.

6. The display device of claim 5, further comprising:
a first polarizer disposed under the first substrate and having a first transmission axis; and
a second polarizer disposed between the second substrate and the optical member and having a second transmission axis crossing the first transmission axis.

7. The display device of claim 5, wherein the second substrate comprises color filters overlapping the openings, respectively.

8. The display device of claim 2, wherein
the first substrate further comprises a plurality of signal lines,
the second substrate further comprises a light-shielding layer comprising a plurality of openings corresponding to the transmissive parts of the first and second transmissive areas, and
each of the pixels of the first and second pixel rows comprises:
a transistor connected to corresponding signal lines among the plurality of signal lines; and
an organic light emitting element connected to the transistor.

9. The display device of claim 8, further comprising a polarizing plate disposed between the second substrate and the optical member.

10. The display device of claim 1, wherein the left-eye retarder comprises a first optical film having a first slow axis, the right-eye retarder comprises a second optical film having a second slow axis that is different from the first slow axis, and the image blocking portion comprises a dye or a pigment.

11. The display device of claim 10, wherein the image blocking portion comprises a black layer disposed on the first optical film or the second optical film and comprises the dye or the pigment.

12. The display device of claim 10, wherein the image blocking portion comprises a third optical film disposed between the first optical film and the second optical film and comprises the dye or the pigment.

13. The display device of claim 1, wherein an optical axis of the left-eye retarder differs from an optical axis of the right-eye retarder.

14. A display device comprising:
a first substrate;
a second substrate disposed on the first substrate and comprising a light-shielding layer comprising a first part comprising a plurality of openings, a second part comprising a plurality of openings and disposed in parallel with the first part, and a light-shielding part disposed between the first part and the second part; and
an optical member disposed on the second substrate and comprising a left-eye retarder overlapping the first part, a right-eye retarder overlapping the second part, and an image blocking portion disposed between the left-eye retarder and the right-eye retarder and overlapping the light-shielding part,
wherein a ratio of one of a width of the light-shielding part and a width of the image blocking portion to the other of the width of the light-shielding part and the width of the image blocking portion is in a range of about 1:1 to about 1:0.8.

15. A display device comprising:
a display panel comprising a first display row comprising a plurality of display parts arranged in a first direction, a second display row having a plurality of display parts arranged in the first direction, and a non-display row disposed between the first display row and the second display row, wherein the second display row is separated from the first display row in a second direction perpendicular to the first direction;
a polarizer disposed on the display panel; and
an optical member disposed on the polarizer and comprising a left-eye retarder overlapping the first display row, a right-eye retarder overlapping the second display row, and an image blocking portion disposed between the left-eye retarder and the right-eye retarder and overlapping the non-display row,
wherein a width of the non-display row with respect to the second direction is substantially the same as a width of the image blocking portion with respect to the second direction.

16. The display device of claim 15, wherein the first display row is configured to display a left-eye image and the second display row is configured top display a right-eye image.

17. The display device of claim 16, wherein an optical axis of the left-eye retarder differs from an optical axis of the right-eye retarder.

18. The display device of claim 17, wherein an angle between the optical axis of the left-eye retarder and a transmission axis of the polarizer is about positive 45 degrees, and an angle between the optical axis of the right-eye retarder and the transmission axis of the polarizer is about negative 45 degrees.

19. A display device, comprising:
a plurality of pixels to emit light;
a light blocker configured to block a first portion of the light emitted from the pixels and to transmit a second portion of the light emitted from the pixels;
an optical member configured to receive the second portion of the light emitted from the pixels, the optical member comprising a first area to emit a first eye image, a second area to emit a second eye image, and a third area configured to block a portion of the second portion of the light emitted from the pixels.

20. The display device of claim 19, wherein the third area of the optical member is disposed on both the first area and the second area.

21. The display device of claim 19, wherein the third area of the optical member is disposed between the first area and the second area.
